(19) United States
(12) Patent Application Publication
(10) Pub. No.: US 2015/0029440 A1
(43) Pub. Date: Jan. 29, 2015

(54) BACKLIGHT MODULE AND LIQUID CRYSTAL DISPLAY

(71) Applicant: Jianfa Huang, Shenzhen (CN)

(72) Inventor: Jianfa Huang, Shenzhen (CN)

(73) Assignee: Shenzhen China Star Optoelectronics Technology Co. Ltd., Shenzhen (CN)

(21) Appl. No.: 13/511,658

(22) PCT Filed: Apr. 20, 2012
(86) PCT No.: PCT/CN12/74429

§ 371 Date: May 24, 2012

(30) Foreign Application Priority Data
Apr. 18, 2012 (CN) 201210113695.5

(51) Int. Cl. F21V 8/00

(52) U.S. Cl. CPC G02B 6/0031; G02B 6/005
USPC 349/65; 362/609; 362/606

(57) ABSTRACT

This invention relates to a backlight module and a liquid crystal display where the backlight module comprises a light guide plate, a substrate, a light source, a reflective element and a reflective sheet. The light guide plate and the reflective sheet are joined by a double coated film that is set up along the edge of a lower surface of the light guide plate. A light exit plane of the light source is placed in between the lower surface of the light guide plate and a light exit plane of the light guide plate. By means of altering the setup of the light guide plate and the reflective sheet, this invention settles the technical issue of mura appeared at the corresponding display panel.

### BACKGROUND OF THE INVENTION

1. Field of the Invention

The present invention relates to liquid crystal displays domain, and more particularly, the present invention relates to a backlight module capable of eliminating light leakage at its lower surface and a liquid crystal display.

2. Description of the Prior Art

A liquid crystal display (LCD), having been applied extensively to various electronic products, is largely backlight type of LCD, and comprises a liquid crystal panel and a backlight module. The backlight module is categorized into two types: a side-light type and a direct-light type based on light incident position, for the provision of back light to the liquid crystal panel.

Shown in FIG. 1, FIG. 1 is a schematic diagram of the structure of prior side-light type of the backlight module where 101 is a light guide plate, 102 is a light source, 103 is a reflective element, 104 is a reflective sheet, and 105 is a substrate. Viewing from the figure, due to the existence of the reflective sheet 104, a gap is then occurred in between the light guide plate 101 and the substrate 105 and in between the light guide plate 101 and the reflective sheet 104 respectively. The emitted light from light source 102 can be incident through the bottom of a light incident side of the light guide plate 101, which further forms mura at the corresponding display panel, weightily affecting displaying effect of the LCD.

Therefore, it is quite essential to provide a backlight module and a liquid crystal display device, to settle the existing issues of the prior techniques.

### SUMMARY OF THE INVENTION

The present invention is provided with a backlight module and a liquid crystal display where the setup of the light guide plate and the reflective sheet is altered, to settle the technical issue of mura appeared at the prior backlight module and the liquid crystal display due to a gap occurred in between the light guide plate and the substrate and in between the light guide plate and the reflective sheet respectively.

The present invention relates to a backlight module, comprising a light guide plate; a substrate, disposed at the bottom of a light incident side of the light guide plate; a light source, set up on the substrate; a reflective element, used to reflect the light beam emitted from the light source to a light incident plane of the light guide plate; and a reflective sheet, disposed at the bottom of the light guide plate, used to reflect the light beam onto the lower surface of the light guide plate. The light guide plate and the reflective sheet are joined by a double coated film that is set up along the edge of the lower surface of the light guide plate. A light exit plane of the light source, the lower surface of the light guide plate and a light exit plane of the light guide plate are parallel to one another where the light exit plane of the light source is placed in between the lower surface of the light guide plate and the light exit plane of the light guide plate. The width of the double coated film is D. The distance between the lower surface of the light guide plate and the light exit plane of the light source is H. The refraction index of the light guide plate is n. And the ratio of H to D is greater than 0.8*tan [arc sin (1/n)]. The double coated film is set up along the edge of the incident side of the bottom.

The present invention further relates to a backlight module, comprising a light guide plate; a substrate, disposed at the bottom of a light incident side of the light guide plate; a light source, set up on the substrate; a reflective element, used to reflect the light beam emitted from the light source to a light incident plane of the light guide plate; and a reflective sheet, disposed at the bottom of the light guide plate, used to reflect the light beam onto the lower surface of the light guide plate. The light guide plate and the reflective sheet are joined by a double coated film that is set up along the edge of the lower surface of the light guide plate. A light exit plane of the light source, the lower surface of the light guide plate and a light exit plane of the light guide plate are parallel to one another where the light exit plane of the light source is placed in between the lower surface of the light guide plate and the light exit plane of the light guide plate.

In the backlight module of this invention, the width of the double coated film is D. The distance between the lower surface of the light guide plate and the light exit plane of the light source is H. The refraction index of the light guide plate is n. And the ratio of H to D is greater than 0.8*tan [arc sin (1/n)].

In the backlight module of this invention, the ratio of H to D is greater than tan [arc sin (1/n)].

In the backlight module of this invention, the double coated film is set up along the edge of the incident side of the bottom.

In the backlight module of this invention, the substance used for the light guide plate is light-curable resin, polymethyl methacrylate or polycarbonate.

In the backlight module of this invention, the reflective element is a monoplane reflective plate, a multi-plane reflective plate or a spline surface reflective plate.

In the backlight module of this invention, the substrate is a printed circuit board or a flexible printed circuit board.

In the backlight module of this invention, the backlight module further comprises an optical film where the optical film is disposed on the light exit plane of the light guide plate, for the improvement of the efficiency of emitting light.

The present invention further relates to a liquid crystal display, comprising a light guide plate; a substrate, disposed at the bottom of a light incident side of the light guide plate; a light source, set up on the substrate; a reflective element, used to reflect the light beam emitted from the light source to a light incident plane of the light guide plate; and a reflective sheet, disposed at the bottom of the light guide plate, used to reflect the light beam onto the lower surface of the light guide plate. The light guide plate and the reflective sheet are joined by a double coated film that is set up along the edge of the lower surface of the light guide plate. A light exit plane of the light source, the lower surface of the light guide plate and a light exit plane of the light guide plate are parallel to one another where the light exit plane of the light source is placed in between the lower surface of the light guide plate and the light exit plane of the light guide plate.

In the liquid crystal display of this invention, the width of the double coated film is D. The distance between the lower surface of the light guide plate and the light exit plane of the light source is H. The refraction index of the light guide plate is n. And the ratio of H to D is greater than 0.8*tan [arc sin (1/n)].

In the liquid crystal display of this invention, the ratio of H to D is greater than tan [arc sin (1/n)].

In the liquid crystal display of this invention, the double coated film is set up along the edge of the incident side of the bottom.

In the liquid crystal display of this invention, the substance used for the light guide plate is light-curable resin, polymethyl methacrylate or polycarbonate.

In the liquid crystal display of this invention, the reflective element is a monoplane reflective plate, a multi-plane reflective plate or a spline surface reflective plate.

In the liquid crystal display of this invention, the substrate is a printed circuit board or a flexible printed circuit board.

In the liquid crystal display of this invention, the backlight module further comprises an optical film where the optical film is disposed on the light exit plane of the light guide plate, for the improvement of the efficiency of emitting light.

The implementation of the backlight module and the liquid crystal display of this invention is provided with advantages as follows: by altering the setup of the light guide plate and the reflective sheet, to settle the technical issues of the prior backlight module and the liquid crystal display that mura appears due to a gap occurred in between the light guide plate and the substrate and in between the light guide plate and the reflective sheet respectively.

This invention is detailed described with reference to the following preferred embodiments and the accompanying drawings for better comprehension.

### BRIEF DESCRIPTION OF THE DRAWINGS

FIG. 1 is a schematic diagram of the structure of prior side-light type of a backlight module; and

FIG. 2 is a schematic diagram of the structure of a backlight module of the preferred embodiment of the present invention.

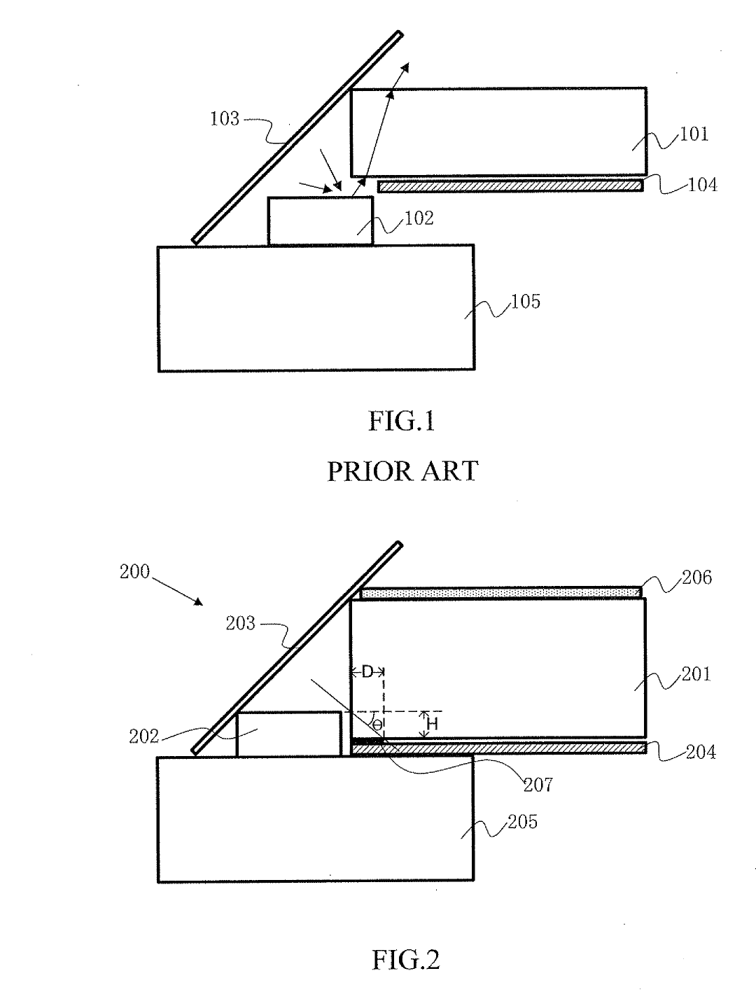

### DETAILED DESCRIPTION OF THE INVENTION

The following embodiments are described with reference to the following accompanying drawings which exemplify the realizations of this invention.

The following embodiments are described with reference to the following accompanying drawings, which exemplify the realization of this invention. The directional terminologies of this invention, for instance: ^{┌}top_{┘}, ^{┌}bottom_{┘}, ^{┌}front_{┘}, ^{┌}back_{┘}, ^{┌}left_{┘}, ^{┌}right_{┘}, ^{┌}inner_{┘}, ^{┌}outer_{┘}, ^{┌}side_{┘} and the like are merely the direction with reference to the accompanying drawings. Therefore, the aforesaid directional terminologies are used to describe and comprehend this invention, instead of limiting this invention.

In the following drawings, objects in similar structure are marked by same numeral.

Referring to FIG. 2, FIG. 2 is a schematic diagram of the structure of a backlight module of the preferred embodiment of the present invention. The backlight module 200 comprising a light guide plate 201, a light source 202, a reflective element 203, a reflective sheet 204, a substrate 205 and a optical film 206. The light guide plate 201 is disposed on a backplane (not shown in the figure), for the guiding of the light beams of the light source 202. The substrate 205 is disposed at the bottom of a light incident side of the light guide plate 201, and is provided with the light source 202 thereon, for side-light emission into the light guide plate 201, and the light beams are guided by the light guide plate 201. The reflective element 203 is disposed at the top of a light incident side of the light guide plate 201, used to reflect the light beam emitted from the light source 202 to a light incident plane of the light guide plate 201. The reflective sheet 204, disposed at the bottom of the light guide plate 201, used to reflect the light beam onto the lower surface of the light guide plate 201. The optical film 206 is disposed on a light exit plane of the light guide plate 201, for the improvement of the efficiency of emitting light of the backlight module 200. In this embodiment, the light guide plate 201 and the reflective sheet 204 are joined by a double coated film 207 where the double coated film 207 is set up along the edge (of course can be disposed at the whole edge of the lower surface) of the lower surface of the light guide plate 201. A light exit plane of the light source 202, the lower surface of the light guide plate 201 and the light exit plane of the light guide plate 201 are parallel to one another where the light exit plane of the light source 202 is placed in between the lower surface of the light guide plate 201 and the light exit plane of the light guide plate 201.

During the use of the backlight module of this embodiment, since the light exit plane of the light source 202, the lower surface of the light guide plate 201 and the light exit plane of the light guide plate 201 are parallel to one another, and the light exit plane of the light source 202 is placed in between the lower surface of the light guide plate 201 and the light exit plane of the light guide plate 201, it can be seen from the figure that the lower surface of the light guide plate 201 is lower than the light exit plane of the light source 202; meanwhile, through the joining of the light guide plate 201 and the reflective sheet 204 by the double coated film 207 at the light incident side of the light guide plate 201, which then assures that the light beam would not come in from the lower surface of the light guide plate 201.

As light beams are incident to the coated area of the double coated film 207, the double coated film 207 may destroy the total reflection of the light guide plate 201, which forms mura at the corresponding display panel; therefore, it must be certain that the double coated film 207 is located at the non-light area of the light guide plate 201. Shown in FIG. 2, the width of the double coated film 207 is D. The distance between the lower surface of the light guide plate 201 and the light exit plane of the light source 202 is H. The refraction index of the light guide plate 201 is n. The following is to exemplify the light guide plate 201 with a substance of polymethyl methacrylate. The refraction index of the polymethyl methacrylate is close to 1.52, and the refraction index of the air is 1. According to the Snell's law of refraction, the maximum refraction angle ⊖ will not exceed arc sin (1/n), that is, 41.1 degree. Once the ratio of H to D is greater than tan[arc sin(1/n)]=0.87, the light beam incident to the light guide plate 201 will not irradiate the double coated film 207, assuring the double coated film 207 to have no influence on the light beam of the light guide plate 201, which guarantees the display quality of the corresponding display panel.

At the same time the light beams incident to the light guide plate 201 in a large angle are very rare; therefore, the user is available to widen the width of the double coated film 207 to a fitted manner, and the influence that the double coated film 207 acts on the light beam of the light guide plate 201 is negligible once the ratio of H to D is tan [arc sin (1/n)] by experimental verification. In the meantime to guarantee the display quality of the corresponding display panel this way, it also assures the coated effect between the light guide plate 201 and the reflective sheet 204, which is uneasy for the light guide plate 201 and the reflective sheet 204 to come off with each other that leads to light leakage at the bottom of the light guide plate 201.

In the backlight module 200 of this invention, the substance used for the light guide plate 201 is light-curable resin, polymethyl methacrylate or polycarbonate. The reflective element 203 is a monoplane reflective plate, a multi-plane reflective plate or a spline surface reflective plate. In this embodiment, the reflective element 203 may be a wedge-shaped reflective member. The light source 202 of this invention is for instance a cold cathode fluorescent lamp (CCFL), a light emitting diode (LED), an organic light emitting diode (OLED), an electro-luminescence (EL), a light bar or above in any combination. The substrate 205 is for instance a printed circuit board (PCB) or a flexible printed circuit board (FPC).

The reflective sheet 204 is a reflective film, and is a substance with high reflection index. The high reflection index substance is for instance silver, aluminum, gold, chromium, copper, indium, iridium, nickel, platinum, rhenium, rhodium, tin, tantalum, tungsten, manganese, alloy the above metals in any combination, resistant to yellowing and heat-tolerant white reflective paint or above substances in any combination, to reflect the light beams.

The optical film 206 of this invention can be a light diffusion sheet, a prism sheet, a turning prism sheet, a brightness enhancement film (BEF), a dual brightness enhancement film (DBEF), non-multilayer reflective polarizer film (DRPF) or above in any combination.

The present invention further relates to a liquid crystal display, comprising a display panel and a backlight module where the backlight module comprises a light guide plate; a substrate, disposed at the bottom of a light incident side of the light guide plate; a reflective element, used to reflect the light beam emitted from the light source to a light incident plane of the light guide plate and a reflective sheet, used to reflect the light beam onto the lower surface of the light guide plate. The light guide plate and the reflective sheet are joined by a double coated film that is set up along the edge of the lower surface of the light guide plate. A light exit plane of the light source, the lower surface of the light guide plate and a light exit plane of the light guide plate are parallel to one another where the light exit plane of the light source is placed in between the lower surface of the light guide plate and the light exit plane of the light guide plate. The width of the double coated film is D. The distance between the lower surface of the light guide plate and the light exit plane of the light source is H. The refraction index of the light guide plate is n. And the ratio of H to D is greater than 0.8*tan [arc sin (1/n)].

The working principle and beneficial effects of the liquid crystal display of the present invention is same or similar to that of the embodiment of the above backlight module, referring to the embodiment of the above backlight module for details.

Knowing from the above, the backlight module and the liquid crystal display of the present invention settle the technical issue of mura appeared at the corresponding display panel due to a gap occurred in between the light guide plate and the substrate and in between the light guide plate and the reflective sheet respectively by altering the setup of the light guide plate and the reflective sheet, which assures simultaneously the double coated film will not affect the light beams in the light guide plate and further guarantees the displaying quality of the corresponding display panel.

In general, although a few preferred embodiments of the present invention have been disclosed, the above preferred embodiments are not used for limiting this invention, and it will be understood by those of ordinary skill in the art that various changes in form and details may be made therein without departing from the spirit and scope of the present invention. The protection scope of the present invention is based on the scope of the appended claims.

What is claimed is:

1. A backlight module, comprising:
a light guide plate;
a substrate, disposed at the bottom of a light incident side of said light guide plate;
a light source, disposed on said substrate; Tangent
a reflective element, used to reflect the light beam emitted from said light source to a light incident plane of said light guide plate; and
a reflective sheet, disposed at the bottom of said light guide plate, used to reflect the light beam onto a lower surface of said light guide plate;
said light guide plate and said reflective sheet being joined by a double coated film that is set up along the edge of the lower surface of said light guide plate where a light exit plane of said light source, the lower surface of said light guide plate and a light exit plane of said light guide plate are parallel to one another and the light exit plane of said light source is placed in between the lower surface of said light guide plate and the light exit plane of said light guide plate;
the width of the double coated film being D, the distance between the lower surface of said light guide plate and the light exit plane of said light source being H, and the refraction index of said light guide plate being n where the ratio of H to D is greater than 0.8*tan[arc sin(1/n)];
the double coated film being set up along the edge of the incident side of the bottom.

2. A backlight module, comprising:
a light guide plate;
a substrate, disposed at the bottom of a light incident side of said light guide plate;
a light source, disposed on said substrate;
a reflective element, used to reflect the light beam emitted from said light source to a light incident plane of said light guide plate; and
a reflective sheet, disposed at the bottom of said light guide plate, used to reflect the light beam onto a lower surface of said light guide plate;
said light guide plate and said reflective sheet being joined by a double coated film, which is set up along the edge of the lower surface of said light guide plate where a light exit plane of said light source, the lower surface of said light guide plate and a light exit plane of said light guide plate are parallel to one another and the light exit plane of said light source is placed in between the lower surface of said light guide plate and the light exit plane of said light guide plate.

3. The backlight module as claimed in claim 2, wherein the width of the double coated film is D, the distance between the lower surface of said light guide plate and the light exit plane of said light source is H, the refraction index of said light guide plate is n and the ratio of H to D is greater than 0.8*tan [arc sin (1/n)].

4. The backlight module as claimed in claim 3, wherein the ratio of H to D is greater than tan [arc sin (1/n)].

5. The backlight module as claimed in claim 2, wherein the double coated film is set up along the edge of a light incident side of the lower surface of said light guide plate.

6. The backlight module as claimed in claim 2, wherein the substance used for said light guide plate is light-curable resin, polymethyl methacrylate or polycarbonate.

7. The backlight module as claimed in claim 2, wherein said reflective element is a monoplane reflective plate, a multi-plane reflective plate or a spline surface reflective plate.

8. The backlight module as claimed in claim 2, wherein said substrate is a printed circuit board or a flexible printed circuit board.

9. The backlight module as claimed in claim 2, wherein the backlight module further comprises an optical film where the optical film is disposed on the light exit plane of said light guide plate, for the improvement of the efficiency of emitting light.

10. A liquid crystal display, comprising: a display panel and a backlight module, wherein the backlight module comprises:
a light guide plate;
a substrate, disposed at the bottom of a light incident side of said light guide plate;
a light source, disposed on said substrate;
a reflective element, used to reflect the light beam emitted from said light source to a light incident plane of said light guide plate; and
a reflective sheet, disposed at the bottom of said light guide plate, used to reflect the light beam onto a lower surface of said light guide plate;
said light guide plate and said reflective sheet being joined by a double coated film, which is set up along the edge of the lower surface of said light guide plate where a light exit plane of said light source, the lower surface of said light guide plate and a light exit plane of said light guide plate are parallel to one another and the light exit plane of said light source is placed in between the lower surface of said light guide plate and the light exit plane of said light guide plate.

11. The liquid crystal display as claimed in claim 10, wherein the width of the double coated film is D, the distance between the lower surface of said light guide plate and the light exit plane of said light source is H, the refraction index of said light guide plate is n and the ratio of H to D is greater than 0.8*tan [arc sin (1/n)].

12. The liquid crystal display as claimed in claim 11, wherein the ratio of H to D is greater than tan [arc sin (1/n)].

13. The liquid crystal display as claimed in claim 10, wherein the double coated film is set up along the edge of a light incident side of the lower surface of said light guide plate.

14. The liquid crystal display as claimed in claim 10, wherein the substance used for said light guide plate is light-curable resin, polymethyl methacrylate or polycarbonate.

15. The liquid crystal display as claimed in claim 10, wherein said reflective element is a monoplane reflective plate, a multi-plane reflective plate or a spline surface reflective plate.

16. The liquid crystal display as claimed in claim 10, wherein said substrate is a printed circuit board or a flexible printed circuit board.

17. The liquid crystal display as claimed in claim 10, wherein the backlight module further comprises an optical film where the optical film is disposed on the light exit plane of said light guide plate, for the improvement of the efficiency of emitting light.
